(19) United States
(12) Patent Application Publication
(10) Pub. No.: US 2026/0299171 A1
(43) Pub. Date: Oct. 1, 2026

(54) OPTICAL LAMINATE AND ARTICLE PROVIDED WITH SAME

(71) Applicant: DEXERIALS CORPORATION, Shimotsuke-shi, Tochigi (JP)

(72) Inventors: Shotaro GENDA, Shimotsuke-shi, Tochigi (JP); Shohei YOSHIDA, Shimotsuke-shi, Tochigi (JP); Meng YAN, Shimotsuke-shi, Tochigi (JP); Naoki USUI, Shimotsuke-shi, Tochigi (JP)

(73) Assignee: DEXERIALS CORPORATION, Shimotsuke-shi, Tochigi (JP)

(21) Appl. No.: 19/477,244

(22) PCT Filed: Apr. 26, 2024
(86) PCT No.: PCT/JP2024/016571

§ 371 Date: Oct. 21, 2025

(30) Foreign Application Priority Data
Apr. 28, 2023 (JP) 2023-074698
Apr. 10, 2024 (JP) 2024-063462
Apr. 22, 2024 (JP) 2024-069031

(51) Int. Cl. G02B 1/115; G02B 1/14

(52) U.S. Cl. CPC G02B 1/115; G02B 1/14

(57) ABSTRACT

An optical laminate includes in the following order: a transparent base material; a hard coat layer; an adhesion layer comprising a sputtered film; an optical function layer in which high refractive index layers and low refractive index layers are alternately laminated; and an antifouling layer. The hard coat layer includes a silica filler. The optical laminate satisfies condition 1 and condition 2. Condition 1: A ratio ((A)/(B)) of the Martens hardness (A) measured from the antifouling layer side of the optical laminate to the Martens hardness (B) measured from the hard coat layer side of a laminate having only the transparent base material and the hard coat layer is 3.6 or less. Condition 2: A difference in contact angle with respect to water between before and after friction is 20° or less, the friction being performed by horizontally reciprocating the steel wool 200 times.

### TECHNICAL FIELD

The present invention relates to an optical laminate and an article provided with the same, and particularly relates to an optical laminate used as an antireflective film and an article provided with the same, which are suitable for a display used by bending, such as a flexible display.

The present application claims priority under JP 2023-074698, which was filed in Japan on Apr. 28, 2023, JP 2024-063462, which was filed in Japan on Apr. 10, 2024, and JP 2024-069031, which was filed in Japan on Apr. 22, 2024, the contents of which are hereby incorporated.

### BACKGROUND ART

In recent years, portable communication terminals such as smartphones and information devices such as notebook PCs provided with foldable displays have been introduced. Even in these displays, an optical laminate such as an antireflective film may be used to reduce surface reflection. The optical laminate used in foldable displays has a higher requirement for durability against bending than non-foldable displays.

For example, in patent document 1, in a hard coat film having an optical function layer composed of a hard coat layer and a sputtered film, it is proposed to improve the bending resistance by setting the ratio of the thickness of the hard coat layer to the optical function layer to a predetermined range.

Furthermore, patent document 2 teaches that the hard coat layer and the antireflective layer are made of resin to improve the bending resistance.

### PRIOR ART LITERATURE

### Patent Documents

Patent Document 1: JP 2022-185597 A
Patent Document 2: JP 2020-74019 A

### SUMMARY OF INVENTION

### Problem to be Solved by Invention

However, in patent document 1, although the wear resistance and bending resistance of the hard coat film may be improved, scratch resistance is not evaluated, and there is room for improvement.

Furthermore, in patent document 2, although the bending resistance of the antireflective film may be improved, the antireflective layer is made of resin, and thus the scratch resistance is inferior.

The present invention has been made in light of the problems described above, and an object thereof is to provide an optical laminate capable of achieving excellent scratch resistance and further improving bending resistance, and an article provided with the same.

### Means for Solving Problem

In order to solve the above problems, the present invention proposes the following means.
[1] An optical laminate having in the following order: a transparent base material; a hard coat layer; an adhesion layer composed of a sputtered film; an optical function layer in which high refractive index layers each composed of a sputtered film and low refractive index layers each having a refractive index lower than that of the high refractive index layer are alternately laminated; and an antifouling layer, wherein the hard coat layer contains a silica filler, and the optical laminate satisfies condition 1 and condition 2 below.

Condition 1: The ratio ((A)/(B)) of the Martens hardness (A) measured from the antifouling layer side of the optical laminate to the Martens hardness (B) measured from the hard coat layer side of a laminate having only the transparent base material and the hard coat layer is 3.6 or less.

Condition 2: The difference in contact angle with respect to water between before and after friction is 20° or less in a case where a friction tester using steel wool conforming to JIS L0849 is used to horizontally reciprocate the steel wool 200 times.
[2] The optical laminate according to [1] above, wherein the silica filler is surface modified by a functional group derived from a silane compound.
[3] The optical laminate according to [2] above, wherein the silane compound is one or a plurality of types selected from vinyl group-containing silane compounds, (meth)acryloyl group-containing silane compounds, amino group-containing silane compounds, isocyanate group-containing silane compounds, isocyanurate group-containing silane compounds, epoxy group-containing silane compounds, and mercapto group-containing silane compounds.
[4] The optical laminate according to [2] above, wherein the silane compound is a (meth)acryloyl group-containing silane compound.
[5] The optical laminate according to [2] above, wherein the hard coat layer contains a binder resin and a silica filler, and the functional group derived from the silane compound has the same functional group as the binder resin.
[6] The optical laminate according to [5] above, wherein the binder resin contains a (meth)acrylate compound, and the functional group derived from the silane compound is a (meth)acryloyl group.
[7] The optical laminate according to [1] above, wherein an average particle size

of the silica filler is 800 nm or less.
[8] The optical laminate according to [1] above, wherein the thickness of the hard coat layer is 0.5 μm or more and 100 μm or less.
[9] The optical laminate according to [1] above, wherein, when the optical laminate is bent 180° so that the surface on which the antifouling layer is formed is on the outside, a stretching rate S (%) of the optical function layer calculated by the following formula (1) satisfies 1.3≤S when a mandrel of the smallest diameter that did not crack is used.

$$S ( \% ) = \{ ( R 2 / R 1 ) - 1 \} \times 100 \qquad ( 1 )$$

(Provided that R2 is a distance from the axial center of the mandrel to the outer surface of the optical laminate, and R1 is a distance from the axial center of the mandrel to a virtual line indicating a position corresponding to ½ of the total thickness of the optical laminate).
[10] The optical laminate according to claim 9 above, wherein, when the optical laminate is bent 180° so that the surface on which the antifouling layer is formed is on the inside, a compression rate C (%) of the optical function layer calculated by the following formula (2) satisfies 4.5≤C when a mandrel of the smallest diameter that did not crack is used.

$$C ( \% ) = \{ 1 - ( R 3 / R 1 ) \} \times 100 \qquad ( 2 )$$

(Provided that R3 is a distance from the axial center of the mandrel to the surface of the antifouling layer side of the optical laminate, and R1 is a distance from the axial center of the mandrel to a virtual line indicating a position corresponding to ½ of the total thickness of the optical laminate).

An article provided with the optical laminate according to any one of [1] to above.

### Effect of the Invention

According to the present invention, it is possible to provide an optical laminate capable of achieving excellent scratch resistance and further improving bending resistance, and an article provided with the same.

### BRIEF DESCRIPTION OF DRAWINGS

FIG. 1 A cross-sectional view illustrating another example of an optical laminate of the present embodiment.

FIG. 2 A cross-sectional view illustrating another example of an optical laminate of the present embodiment.

FIG. 3 A schematic diagram for describing one example of a manufacturing device that may be used in a method for manufacturing the optical laminate of the present embodiment.

### EMBODIMENTS OF INVENTION

The present embodiments will be described in detail below while referencing the drawings as appropriate.

The drawings used in the description below may illustrate characteristic portions in an enlarged scale for the sake of convenience in order to make the characteristics of the present invention easier to understand, and the dimensional ratios and the like of each constituent element may differ from reality. The materials, dimensions, and the like exemplified in the description below are one example, the present invention is not limited thereto, and such can be modified as appropriate within the scope of the effects of the present invention.

### [Optical Laminate]

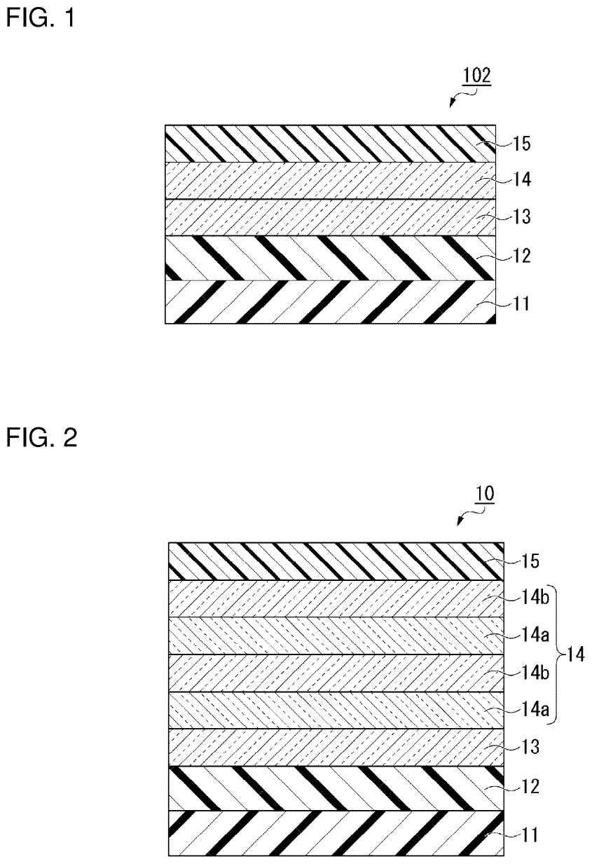

FIG. 1 is a cross-sectional view illustrating another example of an optical laminate of the present embodiment.

An optical laminate 102 illustrated in FIG. 1 is made by laminating in order a transparent base material 11, a hard coat layer 12, an adhesion layer 13, an optical function layer 14, and an antifouling layer 15.

The adhesion layer 13 is a layer that expresses adhesion between the hard coat layer 12 and the optical function layer 14.

The optical function layer 14 is a layer that expresses an optical function. An optical function is a function that controls reflection, transmission, and refraction, which are properties of light, including, for example, an antireflection function, a selective reflection function, a lens function, and the like.

The optical function layer 14 preferably includes any one type selected from the antireflective layer and a selective reflection layer. Known antireflective layers and selective reflection layers may be used. Both the antireflective layer and the selective reflection layer may be monolayers or a laminate of a plurality of layers.

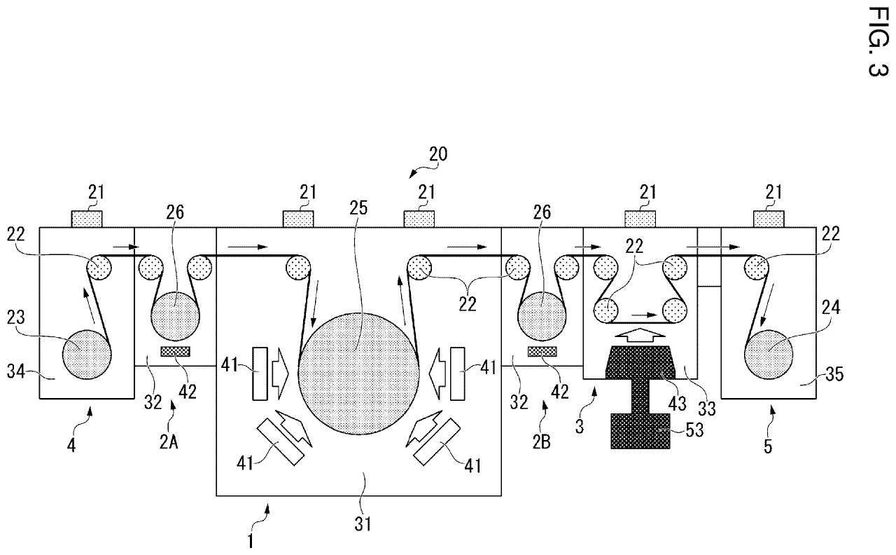

FIG. 2 is a cross-sectional view illustrating another example of an optical laminate of the present embodiment.

An optical laminate 101 illustrated in FIG. 2 is provided with an antireflective layer as the optical function layer 14 in the optical laminate 102 illustrated in FIG. 1. As illustrated in FIG. 1, the optical function layer 14 (antireflective layer) is composed of a laminate in which a low refractive index layer 14b and a high refractive index layer 14a are alternately laminated. The optical function layer 14 illustrated in FIG. 1 is made by laminating in the following order from the transparent base material 11 side: the hard coat layer 12, the adhesion layer 13, the high refractive index layer 14a, the low refractive index layer 14b, the high refractive index layer 14a, the low refractive index layer 14b, and the antifouling layer 15. Therefore, the antifouling layer 15 is in contact with the low refractive index layer 14b of the optical function layer 14.

The transparent base material 11 may be formed from a transparent material capable of transmitting light in the visible light range. For example, a plastic film is preferably used as the transparent base material 11. Specific examples of constituent materials of the plastic film include polyester-based resins, acetate-based resins, polyethersulfone-based resins, polycarbonate-based resins, polyamide-based resins, polyimide-based resins, polyolefin-based resins, (meth)acrylic resins, polyvinyl chloride-based resins, polyvinylidene chloride-based resins, polystyrene-based resins, polyvinyl alcohol-based resins, polyarylate-based resins, and polyphenylene sulfide-based resins.

Note that the term “transparent material” as used in the present invention refers to a material having a transmittance of 80% or more of light in the operating wavelength range within a range that does not impair the effect of the present invention.

Furthermore, in the present embodiment, “(meth)acrylic” means methacrylic and acrylic.

A reinforcing material may be included in the transparent base material 11 to an extent that the optical characteristics are not significantly impaired. The reinforcing material is, for example, cellulose nanofiber, nanosilica, or the like. In particular, polyester-based resins, acetate-based resins, polycarbonate resins, and polyolefin-based resins are suitably used as the reinforcement material. Specifically, a triacetylcellulose (TAC) base material is suitably used as the reinforcing material.

Furthermore, a glass film that is an inorganic base material may also be used for the transparent base material 11.

When the plastic film is a TAC base material, and the hard coat layer 12 is formed on one side thereof, a penetrating layer is formed in which some of the components constituting the hard coat layer 12 penetrate. As a result, the adhesion between the transparent base material 11 and the hard coat layer 12 becomes favorable, and the occurrence of interference fringes caused by the difference in refractive indices between the layers may be suppressed.

The transparent base material 11 may be a film imparted with an optical function and/or a physical function. Examples of films having an optical and/or physical function include polarizing plates, phase difference compensation films, heat ray blocking films, transparent conductive films, brightness-enhancing films, barrier-enhancing films, and the like.

The thickness of the transparent base material 11 is not particularly limited, but is preferably 25 μm or more, for example. It is more preferable that the film thickness of the transparent base material 11 is 40 μm or more.

When the thickness of the transparent base material 11 is 25 μm or more, the rigidity of the base material itself is ensured, and wrinkles are less likely to occur even when stress is applied to an optical laminate 10. Furthermore, it is preferable when the thickness of the transparent base material 11 is 25 μm because wrinkles are less likely to occur and there are fewer manufacturing concerns even when the hard coat layer 12 is continuously formed on the transparent base material 11. It is preferable when the thickness of the transparent base material 11 is 40 μm or more because wrinkles are even less likely to occur.

When implemented by roll during manufacturing, it is preferable that the thickness of the transparent base material 11 is 1,000 μm or less, and is more preferably 600 μm or less. When the thickness of the transparent base material 11 is 1,000 μm or less, the optical laminate 10 during manufacturing and the optical laminate 10 after manufacturing are easily wound into a roll, and the optical laminate 10 may be efficiently manufactured. In addition, when the thickness of the transparent base material 11 is 1,000 μm or less, the optical laminate 10 may be made thinner and lighter. When the thickness of the transparent base material 11 is 600 μm or less, the optical laminate 10 may be produced more efficiently, and may be made thinner and lighter, which is preferable.

The transparent base material 11 may be subjected to an etching treatment and/or an undercoating treatment such as sputtering, corona discharge, ultraviolet irradiation, electron beam irradiation, chemical conversion, and oxidation on the surface in advance. By applying these treatments in advance, adhesion to the hard coat layer 12 formed on the transparent base material 11 may be improved. Furthermore, it is preferable that the surface of the transparent base material 11 is dedusted and cleaned by performing solvent cleaning, ultrasonic cleaning, or the like on the surface of the transparent base material 11 as necessary before forming the hard coat layer 12 on the transparent base material 11.

The hard coat layer 12 has a binder resin and a filler as an essential component and may contain other components such as a dispersant as an optional component. A well-known material may be used as the binder resin. The filler is contained in the binder resin to an extent that transparency is not impaired.

For the filler, a material composed of an organic substance may be used, a material composed of an inorganic substance may be used, or a material composed of an organic substance and an inorganic substance may be used, but from the perspective of hardness and bending resistance, a material composed of an inorganic substance is preferable, and silica particles composed of silica are further preferable. Furthermore, silica particles having surface modification are particularly preferable.

For the binder resin used for the hard coat layer 12, a transparent material is preferable, and for example, ionizing radiation curing resin, thermoplastic resin, thermosetting resin, and the like, which are resins cured by ultraviolet light or electron beams, may be used.

Examples of the ionizing radiation curing resin used in the binder resin of the hard coat layer 12 include ethyl (meth)acrylate, ethyl hexyl (meth)acrylate, styrene, methylstyrene, N-vinylpyrrolidone, and the like.

Furthermore, examples of a compound that is an ionizing radiation-cured resin having 2 or more unsaturated bonds include polyfunctional compounds such as trimethylolpropane tri(meth)acrylate, tripropylene glycol di(meth)acrylate, diethyleneglycol di(meth)acrylate, dipropylene glycol di(meth)acrylate, pentaerythritol tri(meth)acrylate, pentaerythritol tetra(meth)acrylate, dipentaerythritol hexa(meth)acrylate, 1,6-hexanediol di(meth)acrylate, neopentylglycol di(meth)acrylate, trimethylolpropane tri(meth)acrylate, ditrimethylolpropane tetra(meth)acrylate, dipentaerythritol penta(meth)acrylate, tripentaerythritol octa(meth)acrylate, tetrapentaerythritol deca(meth)acrylate, isocyanuric acid tri(meth)acrylate, isocyanuric acid di(meth)acrylate, polyester tri(meth)acrylate, polyester di(meth)acrylate, bisphenol di(meth) diacrylate, diglycerin tetra(meth)acrylate, adamantyl di(meth)acrylate, isobornyl di(meth)acrylate, dicyclopentane di(meth)acrylate, tricyclodecane di(meth)acrylate, ditrimethylolpropane tetra(meth)acrylate, Among these, pentaerythritol triacrylate (PETA), dipentaerythritol hexaacrylate (DPHA), and pentaerythritol tetraacrylate (PETTA) are preferably used. Note that “(meth)acrylate” refers to methacrylate and acrylate. Furthermore, as the ionizing radiation curing resin, a substance in which a compound described above is modified with PO (propylene oxide), EO (ethylene oxide), CL (caprolactone), or the like may also be used. Furthermore, urethane (meth)acrylate oligomers, epoxy (meth)acrylate oligomers, and the like may also be used from the perspective of film formation and viscoelastic adjustment of the hard coat layer.

Examples of the thermoplastic resin used in the binder resin of the hard coat layer 12 include styrene-based resin, (meth)acrylic-based resin, vinyl acetate-based resin, vinyl ether-based resin, halogen-containing resin, alicyclic olefin-based resin, polycarbonate-based resin, polyester-based resin, polyamide-based resin, cellulose derivatives, silicone-based resin, rubber or elastomer, and the like. The thermoplastic resin is preferably amorphous and soluble in an organic solvent (particularly a common solvent capable of dissolving a plurality of polymers and curable compounds). In particular, from the perspective of transparency and weathering resistance, styrene-based resins, (meth)acrylic-based resins, alicyclic olefin-based resins, polyester-based resins, cellulose derivatives (cellulose esters, and the like) and the like are preferable.

The hard coat layer 12 includes, for example, a binder resin and silica particles as a filler. The silica particles preferably include surface-modified silica particles in advance.

Specific examples of the silane compound include vinyl group-containing silane compounds, (meth)acryloyl group-containing silane compounds, amino group-containing silane compounds, isocyanate group-containing silane compounds, isocyanurate group-containing silane compounds, epoxy group-containing silane compounds, mercapto group-containing silane compounds, and the like, and one or a plurality of types of these may be used. The silane compound is appropriately selected according to the type of binder resin, but when a functional group is included in the binder resin, a silane compound having the same functional group as the binder resin is preferable. For example, when the binder resin contains a (meth)acrylate compound as an ionizing radiation curing resin, the silane compound is preferably a (meth)acryloyl group-containing alkoxysilane compound. Note that “(meth)acrylate” refers to methacrylate and/or acrylate. Furthermore, in the present invention, methacrylate and acrylate are treated as the same substance from the perspective of the reaction mechanism. The silane compound used for surface modification preferably has an alkoxysilyl group or a silanol group at the terminus because it bonds well with the hydroxyl group present on the surface of the silica particles.

By surface modifying the silica particles in advance, dispersibility in the binder resin is improved, and due to the reaction between the surface treatment agent used for surface modification and the binder resin, bonds with the binder resin are tighter and hardness of the optical laminate improves.

These silica particles may be exposed to the surface of the optical function layer 14 side of the hard coat layer 12. In this case, the hard coat layer 12 and the optical function layer 14 are more strongly joined via the adhesion layer 13. Methods for exposing include a glow treatment described below, in which case surface modification of the exposed silica surface is removed.

By exposing the filler to the hard coat layer surface and removing the surface modification at that time, an electrostatic attraction is generated between the hydroxyl group generated on the filler surface and the adhesion layer 13, which will be described below, and adhesion is further improved. Furthermore, the fact that the exposed filler digs into the adhesion layer 13 as an anchor also contributes to improving adhesion. The improvement in bending resistance occurs by combining the bond with the binder resin due to surface modification of the silica surface described above and the interaction between the silica and the adhesion layer.

The filler average particle size of the hard coat layer 12 is, for example, 800 nm or less, preferably 780 nm or less, and more preferably 100 nm or less. When the particle size of the filler is within this range, the haze value of the entire optical laminate 10 is 2% or less. The optical laminate 10 having haze of 2% or less has high transparency, resulting in a so-called clear type antireflective film.

The surface of the hard coat layer 12 is preferably subjected to, for example, glow discharge treatment, plasma treatment, ion etching, alkali treatment, or the like. Among these, since large area treatment is possible, glow discharge treatment is preferably used. The intensity during the treatment of the glow discharge treatment may be performed, for example, at an electrode power density of 100 W/m² to 11,000 W/m², and preferably at 1,600 W/m² to 7,000 W/m².

By performing glow discharge treatment on the surface of the hard coat layer 12, the surface of the hard coat layer 12 is roughened at the nano level, and a substance having a weak binding force present on the surface of the hard coat layer 12 is removed. As a result, the adhesion between the hard coat layer 12 and the adhesion layer 13 formed on the hard coat layer 12 is favorable. Furthermore, there is an effect of exposing silica particles from the hard coat layer 12. Furthermore, although the bending resistance described below tends to be improved when the intensity during discharge treatment is increased, the effect plateaus when the discharge strength exceeds a certain level, and the excess glow discharge strength also leads to deterioration of the resin constituting the hard coat layer, so it is preferable to perform glow discharge treatment at the discharge strength in the above range.

Note that when an anti-glare type optical laminate is desired, the average particle size of the filler of the hard coat layer 12 may be, for example, 0.5 μm or more. Organic microparticles such as, for example, acrylic resins are suitably used as fillers of this size. When the particle size of the filler is within this range, the haze value of the entire optical laminate 10 exceeds 2%. The optical laminate 10 having haze exceeding 2% has anti-glare properties, resulting in a so-called anti-glare (AG) type antireflective film. Even in this case, the average particle size of the filler is preferably 10 μm or less, further preferably 5 μm or less, and particularly preferably 3 μm or less.

As a filler contained in the hard coat layer 12, various reinforcements may be used to impart toughness to the hard coat layer 12 to an extent that the optical characteristics are not impaired. Examples of the reinforcing material include, for example, cellulose nanofiber.

The thickness of the hard coat layer 12 is not particularly limited, but for example is preferably 0.5 μm or more, and more preferably 1 μm or more. The thickness of the hard coat layer 12 is preferably 100 μm or less. When the thickness of the hard coat layer 12 is 0.5 μm or more, sufficient hardness is obtained, and thus scratching from manufacturing is less likely to occur. In addition, when the thickness of the hard coat layer 12 is 100 μm or less, the optical laminate 10 may be made thinner and lighter. Furthermore, when the thickness of the hard coat layer 12 is 100 μm or less, microcracks of the hard coat layer 12 that occur when the optical laminate 10 during manufacturing is bent are less likely to occur, resulting in favorable productivity.

The hard coat layer 12 may be a single layer or a plurality of layers may be laminated. Furthermore, the hard coat layer 12 may further be imparted with known functions, for example, ultraviolet absorption performance, antistatic performance, refractive index adjustment function, hardness adjustment function, and the like.

Furthermore, functions imparted to the hard coat layer 12 may be imparted in a single hard coat layer or may be imparted split in a plurality of layers.

The adhesion layer 13 is a layer formed to achieve favorable adhesion between the transparent base material 11 or hard coat layer 12, which is an organic film, and the optical function layer 14, which is an inorganic film. In the optical laminate 10 illustrated in FIG. 2, the adhesion layer 13 is provided between the hard coat layer 12 and the optical function layer 14. The adhesion layer 13 has a function for causing the hard coat layer 12 and the optical function layer 14 to adhere. The adhesion layer 13 is preferably composed of a metal oxide in an oxygen-deficient state or a metal. A metal oxide in an oxygen-deficient state is a metal oxide in which the oxygen number is insufficient compared to the stoichiometric composition. Examples of the metal oxide in an oxygen-deficient state include SiOx, AlOx, TiOx, ZrOx, CeOx, MgOx, ZnOx, TaOx, SbOx, SnOx, MnOx, and the like. Examples of the metal include Si, Al, Ti, Zr, Ce, Mg, Zn, Ta, Sb, Sn, Mn, In, and the like. The adhesion layer 13 may be, for example, such that x in SiOx is greater than 0 and less than 2.0. Furthermore, the adhesion layer may be formed from a mixture of a plurality of metals or metal oxides.

From the viewpoint of maintaining transparency and adhesion to the optical function layer and obtaining favorable optical characteristics, it is preferable that the thickness of the adhesion layer be greater than 0 nm and 20 nm or less, and particularly preferably 1 nm or more and 10 nm or less.

The optical function layer 14 is a laminate that expresses an antireflection function. The optical function layer 14 illustrated in FIG. 2 is a laminate of a total of four layers in which the high refractive index layer 14a and the low refractive index layer 14b are alternately laminated in order from the adhesion layer 13 side. The number of layers of the high refractive index layer 14a and the low refractive index layer 14b is not particularly limited, and the number of layers of the high refractive index layer 14a and the low refractive index layer 14b may be any number of layers.

In the optical laminate 10 illustrated in FIG. 2, the optical function layer 14 is composed of a laminate in which the low refractive index layer 14b and the high refractive index layer 14a are alternately laminated, and thus light incident from the antifouling layer 15 side interferes with each other due to the optical function layer 14, thereby reducing the intensity of reflected light and allowing the antireflection function to be exhibited. Therefore, an antireflection function is obtained that prevents light incident from the antifouling layer 15 side from being reflected in one direction.

The low refractive index layer 14b includes, for example, an oxide of a metal. The low refractive index layer 14b may include an oxide of Si from the viewpoint of ease of acquisition and cost, and is preferably a layer mainly composed of SiO₂ (oxide of Si) or the like. The SiO₂ monolayer film is colorless and transparent. In the present embodiment, a main component of the low refractive index layer 14b means a component included in the low refractive index layer 14b by 50% or more by mass.

When the low refractive index layer 14b is a layer having an oxide of Si as a main component, another element less than 50% by mass may be included. The content of elements different from the oxide of Si is preferably 10% or less. As another element, for example, Na for the purpose of improving durability, Zr, Al, or N for the purpose of improving hardness, and Zr, Al for the purpose of improving alkali resistance may be contained.

The refractive index of the low refractive index layer 14b is preferably 1.20 to 1.60, and more preferably 1.30 to 1.50. Examples of dielectric materials used in the low refractive index layer 14b include magnesium fluoride (MgF₂, refractive index 1.38) and the like.

The refractive index of the high refractive index layer 14a is preferably 2.00 to 2.60, and more preferably 2.10 to 2.45. Examples of the dielectric material used in the high refractive index layer 14a include niobium pentoxide (Nb₂O₅, refractive index 2.33), titanium oxide (TiO₂, refractive index 2.33 to 2.55), tungsten oxide (WO₃, refractive index 2.2), cerium oxide (CeO₂, refractive index 2.2), tantalum pentoxide (Ta₂O₅, refractive index 2.16), zinc oxide (ZnO, refractive index 2.1), indium tin oxide (ITO, refractive index 2.06), zirconium oxide (ZrO₂, refractive index 2.2), and the like.

When it is desired to impart conductive properties to the high refractive index layer 14a, for example, ITO or indium zinc oxide (IZO) may be selected.

For the optical function layer 14, it preferable to use, for example, a layer composed of niobium pentoxide (Nb₂O₅, refractive index 2.33) as the high refractive index layer 14a, and to use a layer composed of SiO₂ as the low refractive index layer 14b.

The film thickness of the low refractive index layer 14b may be in a range of 1 nm or more and 200 nm or less, and is appropriately selected according to a wavelength range that requires an antireflection function.

A film thickness of the high refractive index layer 14a may be, for example, 1 nm or more and 200 nm or less, and is appropriately selected according to a wavelength range that requires an antireflection function.

The film thickness of the high refractive index layer 14a and the low refractive index layer 14b may be respectively appropriately selected according to the design of the optical function layer 14.

For example, in order from the adhesion layer 13 side, a 5 to 50 nm high refractive index layer 14a, a 10 to 80 nm low refractive index layer 14b, a 20 to 200 nm high refractive index layer 14a, and a 50 to 200 nm low refractive index layer 14b may be used.

Among the layers forming the optical function layer 14, the low refractive index layer 14b is disposed on the antifouling layer 15. When the low refractive index layer 14b of the optical function layer 14 is in contact with the antifouling layer 15, it is preferable because the antireflection performance of the optical function layer 14 is favorable.

The antifouling layer 15 is formed on an outermost surface of the optical function layer 14 to prevent contamination of the optical function layer 14. Furthermore, the antifouling layer 15 suppresses wear of the optical function layer 14 by wear resistance when applied to a touch panel or the like.

The antifouling layer 15 of the present embodiment is composed of a vapor deposited film in which an antifouling material is vapor deposited. In the present embodiment, the antifouling layer 15 is formed by vacuum vapor deposition of a fluorine-based organic compound as an antifouling material on one surface of the low refractive index layer 14b configuring the optical function layer 14. In the present embodiment, the antifouling material includes a fluorine-based organic compound, resulting in an optical laminate 10 having better friction resistance and alkali resistance.

As the fluorine-based organic compound constituting the antifouling layer 15, a compound composed of a fluorine-modified organic group and a reactive silyl group (for example, alkoxysilane) is preferably used. Examples of commercial products include OPTOOL DSX (manufactured by Daikin Co., Ltd.), the KY-100 series (manufactured by Shin-Etsu Chemical Co., Ltd.), and the like.

When using a compound composed of a fluorine-modified organic group and a reactive silyl group (for example, alkoxysilane) as the fluorine-based organic compound constituting the antifouling layer 15, and using a layer composed of SiO₂ as the low refractive index layer 14b of the optical function layer 14 in contact with the antifouling layer 15, a siloxane bond is formed between the silanol group, which is the backbone of the fluorine-based organic compound, and SiO₂. Thus, the adhesion between the optical function layer 14 and the antifouling layer 15 is favorable.

The optical thickness of the antifouling layer 15 may be in a range of 1 nm or more and 20 nm or less, preferably in a range of 3 nm or more and 10 nm or less. When the thickness of the antifouling layer 15 is 1 nm or more, wear resistance may be sufficiently ensured when the optical laminate 10 is applied to touch panel applications or the like. Furthermore, when the thickness of the antifouling layer 15 is 3 nm or more, the liquid resistance of the optical laminate 10 and the like are improved. Furthermore, when the thickness of the antifouling layer 15 is 20 nm or less, the time required for vapor deposition is short, and efficient production is possible.

In the optical laminates 10, 102 configured as described above, a ratio ((A)/(B)) of the Martens hardness (A) measured from the antifouling layer 15 side of the optical laminates 10, 102 to the Martens hardness measured from the hard coat layer 12 side of a laminate having only the transparent base material 11 and the hard coat layer 12 is 3.6 or less (condition 1). Furthermore, the ratio ((A)/(B)) is preferably 3.5 or less, and is more preferably 3.4 or less. When the above ratio ((A)/(B)) is 3.6 or less, deformation is suppressed by a decrease in the hardness difference between the hard coat layer surface and the antifouling layer surface, and as a result, excellent scratch resistance may be realized, and bending resistance may be further improved.

Furthermore, in the optical laminates 10, 102 configured as described above the difference in contact angle with respect to water between before and after friction is 20° or less in a case where a friction tester using steel wool conforming to JIS L0849 is used to horizontally reciprocate the steel wool 200 times (condition 2). When the hardness of the optical laminates 10, 102 is high, the difference in the contact angle becomes 20° or less, and excellent scratch resistance may be realized.

In the optical laminates 10, 102 configured as described above, it is preferable that when the optical laminates 10, 102 are bent 180° so that the surface on which the antifouling layer 15 is formed is on the outside, a stretching rate S (%) of the optical function layer 14 calculated by the following formula (1) satisfies 1.3≤S when a mandrel of the smallest diameter that did not crack is used. Thus, the bending resistance of the optical laminates 10, 102 may be further improved.

$$S = \{ ( R 2 / R 1 ) - 1 \} \times 100 \qquad ( 1 )$$

(Here, R2 is a distance from the axial center of the mandrel to the outer surface of the optical laminate, and R1 is a distance from the axial center of the mandrel to a virtual line indicating a position corresponding to ½ of the total thickness of the optical laminate)

Furthermore, in the optical laminates 10, 102, it is preferable that when the optical laminates 10, 102 are bent 180° so that the surface on which the antifouling layer 15 is formed is on the inside, a compression rate C (%) of the optical function layer 14 calculated by the following formula (2) satisfies 4.5≤C when a mandrel of the smallest diameter that did not crack is used, and 5≤C is more preferable. Thus, the bending resistance of the optical laminates 10, 102 may be further improved.

$$C ( \% ) = \{ 1 - ( R 3 / R 1 ) \} \times 100 \qquad ( 2 )$$

(Here, R3 is a distance from the axial center of the mandrel to the surface of the antifouling layer side of the optical laminate, and R1 is a distance from the axial center of the mandrel to a virtual line indicating a position corresponding to ½ of the total thickness of the optical laminate)

Furthermore, the optical function layer 14 preferably satisfies both the above range of stretching rate S (%) and the above range of compression rate C (%). That is, in the optical laminates 10, 102, it is preferable that when the optical laminates 10, 102 are bent 180° so that the surface on which the antifouling layer 15 is formed is on the outside, the stretching rate S (%) of the optical function layer 14 calculated by formula (1) below satisfies 1.3≤S when a mandrel of the smallest diameter that did not crack is used, and that when the optical laminates 10, 102 are bent 180° so that the surface on which the antifouling layer 15 is formed is on the inside, the compression rate C (%) of the optical function layer 14 calculated by formula (2) below satisfies 4.5≤C when a mandrel of the smallest diameter that did not crack is used. Thus, the bending resistance of the optical laminates 10, 102 may be further improved.

Note that the above stretching rate is a value when the base material is PET and the thickness is 50 μm, and this value may vary when this thickness becomes thinner.

In the optical laminates 10, 102 configured as described above, when the thickness of the hard coat layer of the optical laminate is 5 μm thick and the optical laminates 10, 102 are bent 180° so that the surface on which the antifouling layer 15 is formed is on the outside, the diameter of the mandrel is gradually replaced with a smaller one, and it is preferable that the diameter of the mandrel, which is 0.2 mm larger than the diameter of the mandrel on which cracks were first found, is 4.0 φmm or less, more preferably 3.5 φmm or less, and 3.0 φmm or less.

Furthermore, when the thickness of the hard coat layer of the optical laminate is 5 μm and the optical laminates 10, 102 are bent 180° so that the surface on which the antifouling layer 15 is formed is on the inside, the diameter of the mandrel is gradually replaced with a smaller one, and it is preferable that the diameter of the mandrel, which is 0.2 mm larger than the diameter of the mandrel on which cracks were first found, is 1.1 φmm or less, and is more preferably less than 1.0 φmm.

Moreover, it is preferable that when the thickness of the hard coat layer of the optical laminate is 5 μm thick and the optical laminates 10, 102 are bent 180° so that the surface on which the antifouling layer 15 is formed is on the outside, the diameter of the mandrel is gradually replaced with a smaller one, and the diameter of the mandrel, which is 0.2 mm larger than the diameter of the mandrel on which cracks were first found, is 4.0 φmm or less, and that when the optical laminates 10, 102 are bent 180° so that the surface on which the antifouling layer 15 is formed is on the inside, the diameter of the mandrel is gradually replaced with a smaller one, and the diameter of the mandrel, which is 0.2 mm larger than the diameter of the mandrel on which cracks were first found, is 1.1 φmm or less.

In the optical laminates 10, 102 configured as described above, when the thickness of the hard coat layer of the optical laminate is 10 μm thick and the optical laminates 10, 102 are bent 180° so that the surface on which the antifouling layer 15 is formed is on the outside, the diameter of the mandrel is gradually replaced with a smaller one, and it is preferable that the diameter of the mandrel, which is 0.2 mm larger than the diameter of the mandrel on which cracks were first found, is 4.0 mm or less, more preferably 3.5 mm or less, and 3.0 φmm or less.

Furthermore, when the thickness of the hard coat layer of the optical laminate is 10 μm and the optical laminates 10, 102 are bent 180° so that the surface on which the antifouling layer 15 is formed is on the inside, the diameter of the mandrel is gradually replaced with a smaller one, and it is preferable that the diameter of the mandrel, which is 0.2 mm larger than the diameter of the mandrel on which cracks were first found, is 1.4 φmm or less, and is more preferably 1.2 mm or less.

Moreover, it is preferable that when the thickness of the hard coat layer of the optical laminate is 10 μm thick and the optical laminates 10, 102 are bent 180° so that the surface on which the antifouling layer 15 is formed is on the outside, the diameter of the mandrel is gradually replaced with a smaller one, and the diameter of the mandrel, which is 0.2 mm larger than the diameter of the mandrel on which cracks were first found, is 4.0 φmm or less, and that when the optical laminates 10, 102 are bent 180° so that the surface on which the antifouling layer 15 is formed is on the inside, the diameter of the mandrel is gradually replaced with a smaller one, and the diameter of the mandrel, which is 0.2 mm larger than the diameter of the mandrel on which cracks were first found, is 1.4 0 mm or less.

In the optical laminates 10, 102 configured as described above, when the thickness of the hard coat layer of the optical laminate is 2 μm thick and the optical laminates 10, 102 are bent 180° so that the surface on which the antifouling layer 15 is formed is on the outside, the diameter of the mandrel is gradually replaced with a smaller one, and it is preferable that the diameter of the mandrel, which is 0.2 mm larger than the diameter of the mandrel on which cracks were first found, is 4.0 φmm or less, more preferably 3.5 φmm or less, and 3.0 φmm or less.

Furthermore, when the thickness of the hard coat layer of the optical laminate is 2 μm and the optical laminates 10, 102 are bent 180° so that the surface on which the antifouling layer 15 is formed is on the inside, the diameter of the mandrel is gradually replaced with a smaller one, and it is preferable that the diameter of the mandrel, which is 0.2 mm larger than the diameter of the mandrel on which cracks were first found, is 1.1 φmm or less, and is more preferably less than 1.0 φmm.

Moreover, it is preferable that when the thickness of the hard coat layer of the optical laminate is 2 μm thick and the optical laminates 10, 102 are bent 180° so that the surface on which the antifouling layer 15 is formed is on the outside, the diameter of the mandrel is gradually replaced with a smaller one, and the diameter of the mandrel, which is 0.2 mm larger than the diameter of the mandrel on which cracks were first found, is 4.0 φmm or less, and that when the optical laminates 10, 102 are bent 180° so that the surface on which the antifouling layer 15 is formed is on the inside, the diameter of the mandrel is gradually replaced with a smaller one, and the diameter of the mandrel, which is 0.2 mm larger than the diameter of the mandrel on which cracks were first found, is 1.1 mm or less.

Note that the mandrel diameter described above is calculated by cutting out three identical samples and measuring the average value of three measurements.

### [Manufacturing Method of Optical Laminate]

The optical laminate 10 of the present embodiment illustrated in FIG. 2 may be produced, for example, by the method shown below.

In the present embodiment, an example will be described of a case where the optical laminate 10 is manufactured using a transparent base material 11 wound in a roll as an example of a method for manufacturing the optical laminate 10.

First, the transparent base material 11 wound in a roll is unwound. Then, a slurry including a material that forms the hard coat layer 12 is applied on the transparent base material 11 by a known method, and cured by a known method corresponding to the material that forms the hard coat layer 12. Examples of the slurry used include a composition including a binder resin and silica particles as a filler, and this composition is applied on the transparent base material 11 and then cured. Thus, the hard coat layer 12 is formed on the transparent base material 11 (hard coat layer forming step). The above composition may contain one or a plurality of additives such as a polymerization initiator, leveling agent, or the like as necessary. For example, a photo-polymerization initiator is used as a polymerization initiator. Thereafter, the transparent base material 11 on which the hard coat layer 12 is formed on the surface is wound into a roll by a known method.

Next, an adhesion layer forming step for forming the adhesion layer 13 and an optical function layer forming step for forming the optical function layer 14 are performed on the hard coat layer 12. Thereafter, an antifouling layer forming step of forming the antifouling layer 15 on the optical function layer 14 is performed. In the present embodiment, it is preferable that before the optical function layer forming step, a first surface treatment step for treating the surface of the hard coat layer 12 is performed, and then the adhesion layer forming step and the optical function layer forming step are performed. Furthermore, in the present embodiment, it is preferable that after the optical function layer forming step, a second surface treatment step for treating the surface of the optical function layer 14 is performed, and then the antifouling layer forming step is performed.

In the method for manufacturing the optical laminate 10 of the present embodiment, it is preferable that the first surface treatment step, the adhesion layer forming step, the optical function layer forming step, the second surface treatment step, and the antifouling layer forming step are performed continuously while maintaining the optical laminate during manufacturing under reduced pressure. When the first surface treatment step, the adhesion layer forming step, the optical function layer forming step, the second surface treatment step, and the antifouling layer forming step are performed continuously while maintaining the optical laminate during manufacturing under reduced pressure, for example, a device provided with the thin film forming device taught in patent document 4 or the like may be used as a sputtering device.

Specifically, a manufacturing device 20 illustrated in FIG. 3 is an example of a manufacturing device which may be used in the method for manufacturing the optical laminate of the present embodiment.

The manufacturing device 20 illustrated in FIG. 3 is provided with a roll unwinding device 4, a preprocessing device 2A, a sputtering device 1, a preprocessing device 2B, a vapor deposition device 3, and a roll winding device 5. As illustrated in FIG. 3, these devices 4, 2A, 1, 2B, 3, and 5 are connected in this order. The manufacturing device 20 illustrated in FIG. 3 is a roll-to-roll manufacturing device that continuously forms a plurality of layers on a base material by unwinding a base material from a roll and passing such through connected devices continuously (in FIG. 3, preprocessing device 2A, sputtering device 1, preprocessing device 2B, and vapor deposition device 3), then winding up.

When the optical laminate 10 is manufactured using a roll-to-roll manufacturing device, the conveyance speed (line speed) of the optical laminate 10 during manufacturing may be set as appropriate. The conveyance speed is preferably set to, for example, 0.5 to 20 m/min, and more preferably 0.5 to 10 m/min.

### <Roll Unwinding Device>

The roll unwinding device 4 illustrated in FIG. 3 has a chamber 34 whose inside is set to a predetermined depressurized atmosphere, one or a plurality of a vacuum pump 21 (one in FIG. 3) for discharging gas in the chamber 34 to create a depressurized atmosphere, and an unwinding roll 23 and guide roll 22 installed in the chamber 34. As illustrated in FIG. 3, the chamber 34 is connected to a chamber 31 of the sputtering device 1 via the preprocessing device 2A.

The transparent base material 11 having the hard coat layer 12 formed on the surface is wound around the unwinding roll 23. The unwinding roll 23 supplies the transparent base material 11 having the hard coat layer 12 formed on the surface to the preprocessing device 2A at a predetermined conveyance speed.

### <Preprocessing Device 2A>

The preprocessing device 2A illustrated in FIG. 3 has a chamber 32 whose inside is set to a predetermined depressurized atmosphere, a can roll 26, a plurality (two in FIG. 3) of the guide roll 22, and a plasma discharge device 42. As illustrated in FIG. 3, the can roll 26, the guide roll 22, and the plasma discharge device 42 are installed in the chamber 32. As illustrated in FIG. 3, the chamber 32 is connected to the chamber 31 of the sputtering device 1.

The can roll 26 and the guide roll 22 convey the base material 11 on which the hard coat layer 12 is formed sent from the roll unwinding device 4 at a predetermined conveyance speed, and the transparent base material 11 on which the surface of the hard coat layer 12 is treated is fed to the sputtering device 1.

As illustrated in FIG. 3, the plasma discharge device 42 is disposed facing an outer peripheral surface of the can roll 26 at a predetermined interval. The plasma discharge device 42 ionizes gas by glow discharge. The gas is preferably inexpensive and inert and does not affect optical properties, and for example, argon gas, oxygen gas, nitrogen gas, helium gas, and the like may be used. In the present embodiment, it is preferable to use argon gas or oxygen gas as the gas.

### <Sputtering Device>

The sputtering device 1 illustrated in FIG. 3 has the chamber 31 whose inside is set to a predetermined depressurized atmosphere, one or a plurality of the vacuum pump 21 (two in FIG. 3) for discharging gas in the chamber 31 to create a depressurized atmosphere, a deposition roll 25, a plurality (two in FIG. 4) of the guide roll 22, and a plurality (four in the example illustrated in FIG. 3) of a deposition unit 41. As illustrated in FIG. 3, the deposition roll 25, the guide roll 22, and the deposition unit 41 are installed in the chamber 31. As illustrated in FIG. 3, the chamber 31 is connected to the chamber 32 of the preprocessing device 2B.

The deposition roll 25 and the guide roll 22 convey the base material 11 on which the hard coat layer 12 is formed whose surface is treated sent from the preprocessing device 2A at a predetermined conveyance speed, and the transparent base material 11 on which the adhesion layer 13 and the optical function layer 14 are formed on the hard coat layer 12 is fed to the preprocessing device 2B.

In the sputtering device 1 illustrated in FIG. 3, the adhesion layer 13 is laminated by sputtering on the hard coat layer 12 of the transparent base material 11 traveling on the deposition roll 25, and the high refractive index layer 14a and the low refractive index layer 14b are alternately laminated thereon to form the optical function layer 14.

The deposition unit 41, as illustrated in FIG. 3, is disposed facing an outer peripheral surface of the deposition roll 25 at a predetermined interval, and a plurality is installed surrounding the deposition roll 25. A number of the deposition unit 41 is determined according to the total number of laminated layers of the adhesion layer 13 and the high refractive index layer 14a and low refractive index layer 14b forming the optical function layer 14. When it is difficult to secure a distance between adjacent deposition units 41 due to a large total number of laminated layers of the adhesion layer 13 and the high refractive index layer 14a and low refractive index layer 14b forming the optical function layer 14, a plurality of the deposition roll 25 may be provided in the chamber 31, and the deposition unit 41 disposed around each deposition roll 25. When a plurality of the deposition roll 25 is provided, additional guide rolls 22 may be installed as necessary. A plurality of the chamber 31 provided with the deposition roll 25 and the deposition unit 41 may be connected. Furthermore, the diameter of the deposition roll 25 may be changed as appropriate in order to facilitate securing a distance between adjacent deposition units 41.

A respective predetermined target (not illustrated) is installed in each deposition unit 41. A voltage is applied to the target by a known structure. In the present embodiment, a gas supplying unit (not illustrated) for supplying a predetermined reactive gas and a carrier gas to the target at a predetermined flow rate, and a known magnetic field source (not illustrated) for forming a magnetic field on the surface of the target are provided near the target.

The material of the target and the type and flow rate of the reactive gas are appropriately determined according to the composition of the adhesion layer 13, the high refractive index layer 14a, and the low refractive index layer 14b formed on the transparent base material 11 by passing between the deposition unit 41 and the deposition roll 25. For example, when forming a layer composed of SiO₂, Si is used as the target, and O2 is used as the reactive gas. Furthermore, for example, when forming a layer composed of Nb₂O₅, Nb is used as the target and O2 is used as the reactive gas. The low refractive index layer 14b is preferably deposited at a vacuum degree of less than 0.5 Pa, and the high refractive index layer 14a is preferably deposited at a vacuum degree of less than 1.0 Pa. When these layers are deposited at the vacuum level, the optical function layer 14 becomes dense, water vapor transmittance decreases, and durability and the like is improved.

In the present embodiment, from the viewpoint of increasing deposition rate, it is preferable to use a magnetron sputtering method as the sputtering method.

Note that the sputtering method is not limited to the magnetron sputtering method, and a two-pole sputtering method utilizing plasma generated by DC glow discharge or high frequency, a three-pole sputtering method adding a hot cathode, or the like may be used.

The sputtering device 1 is provided with an optical monitor (not illustrated) as a measurement unit for measuring optical characteristics after depositing each layer serving as the adhesion layer 13 and the optical function layer 14. Thus, the quality of the formed adhesion layer 13 and the optical function layer 14 may be confirmed. When the sputtering device 1 has, for example, two or more chambers, it is preferable to install an optical monitor in each chamber.

Examples of an optical monitor (not illustrated), include, for example, one which measures an optical characteristic in the width direction of the adhesion layer 13 and the optical function layer 14 formed on the hard coat layer 12 by an optical head capable of scanning in the width direction. When such an optical monitor is provided, for example, an optical thickness distribution in the width direction of the adhesion layer 13 and the optical function layer 14 may be measured by measuring a peak wavelength of reflectance as an optical characteristic and converting it to an optical thickness. By measuring optical characteristics using the optical monitor, the optical laminate 10 provided with the adhesion layer 13 and the optical function layer 14 having optimum optical characteristics may be formed while adjusting the sputtering conditions in real time.

### <Preprocessing Device 2B>

The preprocessing device 2B illustrated in FIG. 3 has the chamber 32 whose inside is set to a predetermined depressurized atmosphere, the can roll 26, a plurality (two in FIG. 3) of the guide roll 22, and a plasma discharge device 42. As illustrated in FIG. 3, the can roll 26, the guide roll 22, and the plasma discharge device 42 are installed in the chamber 32. As illustrated in FIG. 3, the chamber 32 is connected to a chamber 33 of the vapor deposition device 3.

The can roll 26 and the guide roll 22 convey the base material 11 on which each layer up to the optical function layer 14 is formed sent from the sputtering device 1 at a predetermined conveyance speed, and the transparent base material 11 on which the surface of the optical function layer 14 is treated is fed to the vapor deposition device 3.

For example, a device similar to the preprocessing device 2A may be used as the plasma discharge device 42.

### <Vapor Deposition Device>

The vapor deposition device 3 illustrated in FIG. 4 has the chamber 33 whose inside is set to a predetermined depressurized atmosphere, one or a plurality of the vacuum pump 21 (one in FIG. 3) for discharging gas in the chamber 33 to create a depressurized atmosphere, a plurality (four in FIG. 3) of the guide roll 22, a vapor deposition source 43, and a heating device 53. As illustrated in FIG. 3, the guide roll 22 and the vapor deposition source 43 are installed in the chamber 33. The chamber 33 is connected to a chamber 35 of the roll winding device 5.

The vapor deposition source 43 is disposed opposite the transparent base material 11 on which the surface of the optical function layer 14 is treated, which is substantially horizontally conveyed between two adjacent guide rolls 22. The vapor deposition source 43 supplies an evaporated gas composed of a material serving as the antifouling layer 15 to the optical function layer 14. The direction of the vapor deposition source 43 may set to any direction.

The heating device 53 heats the material serving as the antifouling layer 15 to a vapor pressure temperature. As the heating device 53, a device which heats using a resistance heating method, a heater heating method, an induction heating method, an electron beam method, and the like may be used. In the resistance heating method, a container containing an antifouling material serving as the antifouling layer 15 is energized and heated as a resistor. In the heater heating method, the container is heated by a heater disposed around the periphery of the container. In the induction heating method, the container or the antifouling material is heated by electromagnetic induction from an induction coil installed externally.

The vapor deposition device 3 illustrated in FIG. 3 is provided with a guide plate (not illustrated) for guiding the vapor deposition material evaporated by the vapor deposition source 43 to a predetermined position, a film thickness meter (not illustrated) for observing the thickness of the antifouling layer 15 formed by vapor deposition, a vacuum pressure gauge (not illustrated) for measuring pressure in the chamber 33, and a power supply device (not illustrated).

The guide plate may have any shape as long as the evaporated vapor deposition material may be guided to a desired position. The guide plate need not be provided if not necessary.

For example, an ion gauge or the like may be used as the vacuum pressure gauge.

Examples of the power supply device include high-frequency power sources and the like.

### <Roll Winding Device>

The roll winding device 5 illustrated in FIG. 3 has the chamber 35 whose inside is set to a predetermined depressurized atmosphere, one or a plurality of the vacuum pump 21 (one in FIG. 3) for discharging gas in the chamber 35 to create a depressurized atmosphere, and a winding roll 24 and guide roll 22 installed in the chamber 35.

The transparent base material 11 (optical laminate 10) having each layer up to the antifouling layer 15 formed on the surface is wound around the winding roll 24. The winding roll 24 and the guide roll 22 wind the optical laminate 10 at a predetermined winding speed.

Carrier film may also be used as necessary.

For example, a dry pump, an oil rotary pump, a turbomolecular pump, an oil diffusion pump, a cryopump, a sputter ion pump, a getter pump, and the like may be used as the vacuum pump 21 provided in the manufacturing device 20 illustrated in FIG. 4. The vacuum pump 21 may be used in each chamber 31, 32, 33, 34, 35 in appropriate selection or combination to create a desired depressurized state.

The vacuum pump 21 may maintain both the chamber 31 of the sputtering device 1 and the chamber 33 of the vapor deposition device 3 in a desired depressurized state, and the installation position and number of the vacuum pump 21 in the manufacturing device 20 are not particularly limited. Furthermore, in the manufacturing device 20 illustrated in FIG. 3, the roll unwinding device 4, the preprocessing device 2A, the sputtering device 1, the preprocessing device 2B, the vapor deposition device 3, and the roll winding device 5 are connected. Therefore, the vacuum pump 21 may be installed in the chambers 31, 32, 33, 34, 35, respectively, or may be installed in only a portion of the chambers 31, 32, 33, 34, 35, as long as both the chamber 31 of the sputtering device 1 and the chamber 33 of the vapor deposition device 3 may be maintained in a desired depressurized state.

Next, a method using the manufacturing device 20 illustrated in FIG. 3 to perform the first surface treatment step, the adhesion layer forming step, the optical function layer forming step, the second surface treatment step, and the antifouling layer forming step continuously while maintaining the optical laminate 10 during manufacturing under reduced pressure will be described.

First, the unwinding roll 23 in which the transparent base material 11 having the hard coat layer 12 formed on the surface is wound is installed in the chamber 34 of the roll unwinding device 4. Then, the unwinding roll 23 and the guide roll 22 are rotated and the transparent base material 11 having the hard coat layer 12 formed on the surface is fed to the preprocessing device 2A at a predetermined conveyance speed.

Next, in the chamber 32 of the preprocessing device 2A, the first surface treatment step is performed as pretreatment for the surface on which the adhesion layer 13 and the optical function layer 14 are formed. In the present embodiment, the first surface treatment step is performed on the transparent base material 11 on which the hard coat layer 12 is formed.

In the first surface treatment step, the can roll 26 and the guide roll 22 are rotated to process the surface of the hard coat layer 12 traveling on the can roll 26 while conveying the transparent base material 11 on which the hard coat layer 12 is formed at a predetermined conveyance speed.

As a surface treatment method of the hard coat layer 12, for example, glow discharge treatment, plasma treatment, ion etching, alkali treatment, or the like may be used. As described above, among these, since large area treatment is possible, glow discharge treatment is preferably used.

Next, the adhesion layer forming step and the optical function layer forming step are performed in the chamber 31 of the sputtering device 1. Specifically, the deposition roll 25 and the guide roll 22 are rotated to form the adhesion layer 13 and the optical function layer 14 on the hard coat layer 12 traveling on the deposition roll 25 while conveying the transparent base material 11 on which the hard coat layer 12 is formed at a predetermined conveyance speed.

In the present embodiment, the material of the target installed in each deposition unit 41 or the type and flow rate of the reactive gas supplied from the gas supplying unit are changed and sputtered to form the adhesion layer 13, on which the high refractive index layer 14a and the low refractive index layer 14b are alternately laminated. That is, the adhesion layer forming step and the optical function layer forming step are continuously performed in the sputtering device 1. Thus, the adhesion layer 13 and the optical function layer 14, which is the antireflective layer, are formed.

The high refractive index layer 14a and the low refractive index layer 14b are deposited under a respective predetermined vacuum degree or less. Specifically, the high refractive index layer 14a is deposited at a vacuum degree of less than 1.0 Pa, and the low refractive index layer 14b is deposited at a vacuum degree of less than 0.5 Pa.

When depositing a SiOx film as the adhesion layer 13, it is preferable to form the film using a silicon target by reactive sputtering in a mixed gas atmosphere of oxygen gas and argon gas.

In a case where the adhesion layer 13, the high refractive index layer 14a, and the low refractive index layer 14b are continuously laminated by sputtering, the material of the target may be changed and deposited during the deposition of the adhesion layer 13, the deposition of the high refractive index layer 14a, and the deposition of the low refractive index layer 14b. Furthermore, for example, one type of material may be used as the target, and by changing the oxygen (reactive gas) flow rate during sputtering, alternating layers composed of the target material and layers composed of an oxide of the target material may be formed, and the adhesion layer 13, the high refractive index layer 14a, and the low refractive index layer 14b made.

The pressure during sputtering for forming the adhesion layer 13 and the optical function layer 14 varies depending on the metal being sputtered, but may be 2 Pa or less, is preferably 1 Pa or less, is more preferably 0.6 Pa or less, and particularly preferably 0.2 Pa or less. When the pressure during sputtering is in a state of reduced pressure of 1 Pa or less, the mean free path of a deposited molecule is prolonged, and lamination is performed while the energy of the deposited molecule is high, resulting in a denser, more favorable film. It is preferable that the pressure during sputtering of the high refractive index layer and the low refractive index layer be different. This is because the mean free path differs for each deposited type. By changing the pressure for each deposited type, a denser film may be deposited.

Thereafter, the transparent base material 11 having the adhesion layer 13 and the optical function layer 14 formed on the hard coat layer 12 is fed to the preprocessing device 2B by rotation of the deposition roll 25 and the guide roll 22.

Next, in the chamber 32 of the preprocessing device 2B, the second surface treatment step is performed as pretreatment for the surface on which the antifouling layer 15 is formed. In the present embodiment, the second surface treatment step is performed continuously while maintaining a state of reduced pressure without bringing the transparent base material 11 on which is formed the optical function layer 14 obtained by the optical function layer forming step into contact with the atmosphere.

In the second surface treatment step, the can roll 26 and the guide roll 22 are rotated to perform discharge treatment on the surface of the optical function layer 14 traveling on the can roll 26 while conveying the transparent base material 11 on which each layer up to the optical function layer 14 is formed at a predetermined conveyance speed.

As a surface treatment method of the optical function layer 14, for example, glow discharge treatment, plasma treatment, ion etching, alkali treatment, or the like may be used. Among these, since large area treatment is possible, glow discharge treatment is preferably used.

When discharge treatment is performed on the surface of the optical function layer 14, the surface of the optical function layer 14 is etched, and a surface state of the optical function layer 14 changes. The surface state of the optical function layer 14 is expressed as a surface roughness Ra or an average length RSm of the element. For example, in the case of a clear type antireflective film in which haze of the optical function layer 14 is 2.0 or less, the surface state of the optical function layer 14 is easily defined by the surface roughness Ra. Furthermore, for example, in the case of an AG type antireflective film in which haze of the optical function layer 14 exceeds 2.0, the surface state of the optical function layer 14 is easily defined by the average length RSm of the element. The surface roughness Ra and the average length RSm of the element are measured in accordance with JIS B0601 (ISO4287).

Thereafter, the transparent base material 11 in which the surface of the optical function layer 14 is treated is fed to the vapor deposition device 3 by rotation of the can roll 26 and the guide roll 22.

Next, the antifouling layer forming step is performed in the chamber 33 of the vapor deposition device 3. In the present embodiment, the antifouling layer forming step is performed continuously while maintaining a state of reduced pressure without bringing the transparent base material 11 in which the surface of the optical function layer 14 obtained by the second surface treatment step is treated into contact with the atmosphere.

In the antifouling layer forming step, the guide roll 22 is rotated to vapor deposit the vapor deposition source 43 on the surface of the optical function layer 14 while conveying transparent base material 11 in which the surface of the optical function layer 14 is treated at a predetermined conveyance speed.

In the present embodiment, for example, an antifouling material composed of a fluorine-based organic compound serving as the antifouling layer 15 is heated to a vapor pressure temperature by the heating device 53, the obtained evaporated gas is supplied from the vapor deposition source 43 in a depressurized environment, adhered to the optical function layer 14 whose surface is treated, and the antifouling layer 15 is formed by vacuum vapor deposition.

The pressure when performing vacuum vapor deposition of the antifouling layer 15 is preferably, for example, 0.05 Pa or less, more preferably 0.01 Pa or less, and particularly preferably 0.001 Pa or less. The pressure when performing vacuum vapor deposition is in a state of reduced pressure of 0.05 Pa or less, the mean free path of a deposited molecule is long, and the vapor deposition energy becomes high, resulting in obtaining a denser, more favorable antifouling layer 15.

By the above method, the optical laminate 10 in which the antifouling layer 15 is formed by vacuum vapor deposition is obtained on the adhesion layer 13 and the optical function layer 14 formed by sputtering. After deposition, the antifouling layer 15 preferably has an initial amount of fluorine measured using X-ray fluorescence spectrometry (XRF) of 0.03 or more.

Thereafter, the transparent base material 11 (optical laminate 10) on which each layer up to the antifouling layer 15 is formed is fed to the roll winding device 5 by rotation of the guide roll 22.

Then, the optical laminate 10 is wound around the winding roll 24 by rotation of the winding roll 24 and the guide roll 22 in the chamber 35 of the roll winding device 5.

In the present embodiment, it is preferable that the optical function layer forming step and the antifouling layer forming step are performed continuously under reduced pressure. In particular, when the optical laminate 10 is continuously manufactured as a wound heavy body using a roll-to-roll method, as in the manufacturing method of the present embodiment using the manufacturing device 20 illustrated in FIG. 3, it is more preferable to perform the optical function layer forming step and the antifouling layer forming step continuously inline while maintaining a depressurized state. Inline means that the antifouling layer forming step is performed without bringing the optical function layer 14 formed in the optical function layer forming step into contact with the atmosphere. By performing the optical function layer forming step and the antifouling layer forming step continuously under reduced pressure, production of a natural oxide film on the optical function layer 14 formed in the optical function layer forming step before the antifouling layer 15 is formed is suppressed. Furthermore, contamination such as foreign matter when winding the roll may be prevented from adhering to the optical function layer 14 and inhibiting adhesion between the optical function layer 14 and the antifouling layer 15. Therefore, an optical laminate having favorable adhesion between the optical function layer 14 and the antifouling layer 15 and excellent transparency is obtained compared to when after the optical function layer forming step, the transparent base material 11 in which is formed each layer up to the optical function layer 14 is taken out of the chamber in the depressurized state, and then reinstalled in the chamber.

Furthermore, the antifouling layer 15 of the optical laminate 10 of the present embodiment is a vapor deposited film, and thus, a higher wear resistance is obtained compared to, for example, an antifouling film formed by the application method. This is presumed to be due to the following reasons. That is, pores caused by a solvent included in the paint exist in the antifouling film formed by the application method. In contrast, there are no pores caused by a solvent in the vapor deposited film. Therefore, it is presumed that the vapor deposited film has a higher density than the antifouling film formed by the application method and obtains high wear resistance and alkali resistance.

The method for manufacturing the optical laminate 10 of the present embodiment includes: an adhesion layer forming step for forming the adhesion layer 13, an optical function layer forming step for forming the optical function layer 14 by alternately laminating the high refractive index layer 14a and the low refractive index layer 14b, a second surface treatment step for treating the surface of the optical function layer 14, and an antifouling layer forming step for forming the antifouling layer 15 on the surface treated optical function layer 14. Therefore, the adhesion between the optical function layer 14 and the antifouling layer 15 formed on the optical function layer 14 is favorable, and the friction and alkali resistance are even more favorable.

In the present embodiment, when performing the first surface treatment step, the optical function layer forming step, the second surface treatment step, and the antifouling layer forming step are performed continuously while maintaining the optical laminate during production under reduced pressure, so long as no manufacturing step is impaired, for example, reduced pressure conditions in the chamber may be different between the sputtering device and the vapor deposition device.

In the present embodiment, in any one or more of the steps of the adhesion layer forming step, the optical function layer forming step, and the antifouling layer forming step, it is preferable to measure deposition results over time using a measuring instrument, and to feed the result back to the conditions of the manufacturing step that is the subsequent step. Thus, it is easy to optimize the characteristics of the entire optical laminate, and the characteristics on the surface of the optical laminate may be made uniform. Furthermore, it is also possible to perform feedback on manufacturing conditions in the same process using the measuring instrument. In this case, the layer deposited in the process has uniform and stable characteristics.

In the present embodiment, a case where the second surface treatment step is performed between the optical function layer forming step and the antifouling layer forming step is described as an example, but the second surface treatment step may or may not be performed as necessary. Even when the second surface treatment step is not performed, it is preferable that the optical function layer forming step and the antifouling layer forming step are performed continuously under reduced pressure.

Furthermore, in the manufacturing method in the present embodiment, the optical function layer is deposited under conditions of a predetermined vacuum degree or less. Therefore, the optical function layer 14 becomes dense, water vapor transmittance decreases, and friction resistance and alkali resistance are improved. Moreover, sufficient scratch resistance and alkali resistance may be ensured by the film thickness of the antifouling layer being a predetermined thickness or greater.

In the present embodiment, a case is described as an example in which the optical laminate 10 is continuously manufactured by the roll-to-roll method using the manufacturing device 20 illustrated in FIG. 3, which is provided with the preprocessing device 2A, the sputtering device 1, the preprocessing device 2B, the vapor deposition device 3, the roll unwinding device 4, and the roll winding device 5, but the manufacturing device for manufacturing the optical laminate 10 is not limited to the manufacturing device 20 illustrated in FIG. 3.

For example, a manufacturing device not including the preprocessing device 2A and the preprocessing device 2B, and in which the roll unwinding device 4, the sputtering device 1, the vapor deposition device 3, and the roll winding device 5 are connected in this order may be used.

The manufacturing device 20 illustrated in FIG. 3 may be provided with a pretreatment chamber (not illustrated) for cleaning the surface of the optical function layer 14 on which the antifouling layer 15 is formed between the chamber 33 of the vapor deposition device 3 and the chamber 32 of the preprocessing device 2B.

The manufacturing device 20 illustrated in FIG. 3 may be provided with a post-treatment chamber (not illustrated) for performing cooling and/or inspection of the transparent base material 11 in which each layer up to the antifouling layer 15 is formed between the chamber 33 of the vapor deposition device 3 and the chamber 35 of the roll winding device 5.

The manufacturing device 20 illustrated in FIG. 3 may be provided with a hard coat layer forming device for forming the hard coat layer 12 on the surface of the transparent base material 11 between the roll unwinding device 4 and the sputtering device 1. In this case, not only the optical function layer 14 and the antifouling layer 15, but also the hard coat layer 12 may be continuously manufactured by the roll-to-roll method, which is preferable.

In the present embodiment, a case is described as an example in which an optical function layer forming step is performed using the sputtering device and the antifouling layer forming step is performed using the vapor deposition device, but when the second surface treatment step is not performed, the optical function layer forming step and the antifouling layer forming step may be performed using the same device (in one chamber).

In the optical laminate 10 of the present embodiment, various layers may be provided on a surface opposing the surface on which the optical function layer and the like of the transparent base material are formed, as necessary. For example, an adhesive layer used for bonding to other members may be provided. Furthermore, other optical films may be provided via the adhesive layer. Examples of other optical films include polarization film, phase difference compensation film, film functioning as a half-wave plate or quarter-wave plate, and the like.

Furthermore, a layer having a function such as antireflection, selective reflection, glare prevention, polarization, phase difference compensation, viewing angle compensation or enlargement, light guide, diffusion, brightness improvement, hue adjustment, or conductivity may be directly formed on a surface opposing the transparent base material.

Furthermore, the shape of the optical laminate may be a smooth shape or a shape having a nano-order uneven structure that expresses a motheye or glare-proof function. Furthermore, the shape may be a micro to millimeter order geometric shape such as a lens or prism. The shape may be formed, for example, by a combination of photolithography and etching, shape transfer, thermal pressing, or the like. In the present embodiment, film-forming is performed by vapor deposition or the like, and thus, even when the base material has, for example, an uneven shape, the uneven shape can be maintained.

The article of the present embodiment is provided with the optical laminate 10 described above on a display surface of an image display unit, such as a liquid crystal display panel or an OLED display panel. As a result, for example, high wear resistance and alkali resistance may be imparted to the touch panel display unit of a smartphone or an operating device, and an image display device having excellent durability and suitable for actual use may be realized.

Furthermore, the article is not limited to an image display device, and any optical laminate 10, such as window glass or goggles provided on the surface of the optical laminate of the present embodiment, a light receiving surface of a solar cell, a display such as a smartphone screen or laptop PC, an information input terminal, a tablet terminal, an AR (augmented reality) device, a VR (virtual reality) device, an electric display board, a glass table surface, a game machine, a driving support device of an aircraft or train, a navigation system, an instrument panel, or a surface of an optical sensor may be applicable.

An embodiment of the present invention has been described above, but this embodiment is presented as an example and is not intended to limit the scope of the invention. This embodiment may be implemented in various other forms, and various omissions, substitutions, and changes may be made without departing from the gist of the invention. These embodiments and variations thereof are included in the same scope as the inventions described in the Scope of Patent Claims in the same manner as the scope and abstract of the invention.

For example, instead of the hard coat layer 12, an anti-glare layer may be formed or any functional layer may be added as necessary, such as a flexible soft coat layer. These may be laminated.

### EXAMPLES

Examples of the present invention will be described below. Note that the optical laminates created in the following examples and comparative examples are examples that function as an antireflective film, and the gist of the present invention is not limited thereto.

### <Preparation of Composition for Hard Coat Layer>

First, a photocurable composition 1 was prepared in which the content of silica particles (fillers) having an average particle size of 50 nm was 28% by mass relative to the total solid content of the composition. As shown in Table 1, composition 1 was adjusted by dissolving an acrylate (binder resin), silica particles, and a photo-polymerization initiator in a solvent, and further adding a leveling agent.

TABLE 1

| | Product | | | Composition | Composition | Composition | Composition |
|---|---|---|---|---|---|---|---|
| | name | Manufacturer | Structure, etc. | 1 (mass %) | 2 (mass %) | 3 (mass %) | 4 (mass %) |
| Alkylate | CN968 | Sartomer | Urethane acrylate | 8 | 11 | 7 | 8 |
| | | | oligomer | | | | |
| | SR444 | Sartomer | Pentaerythritol | 7 | — | 6 | 7 |
| | | | triacrylate | | | | |
| | SR610 | Sartomer | Polyethylene | 11 | 15 | 9 | 11 |
| | | | glycol (600) | | | | |
| | | | diacrylate | | | | |
| Silica particles | PGMAC- | Nissan | Silica sol surface | 37 | 37 | 49 | — |
| | 4130Y | Chemical | modified by | | | | |
| | | | methacryloyl | | | | |
| | | | group-containing | | | | |
| | | | alkoxysilane | | | | |
| | | | compound | | | | |
| | | | Particle diameter | | | | |
| | | | 40 to 50 nm | | | | |
| | | | (Solid content 30 | | | | |
| | | | mass %, dispersion | | | | |
| | | | medium PGMA) | | | | |
| | IPA-ST-L | Nissan | Silica sol, no | — | — | — | 37 |
| | | Chemical | surface | | | | |
| | | | modification | | | | |
| | | | Particle diameter | | | | |
| | | | 40 to 50 nm | | | | |
| | | | (Solid content 30 | | | | |
| | | | mass %, dispersion | | | | |
| | | | medium IPA) | | | | |
| Polymerization | Ominirad | IGM | 1-hydroxycyclohexyl | 2 | 2 | 2 | 2 |
| initiator | 184 | | phenyl ketone | | | | |
| Solvent | — | — | Propylene glycol | 30 | 30 | 24 | 30 |
| | | | monoethyl ether | | | | |
| | | | acetate | | | | |
| | — | — | Butyl acetate | 5 | 5 | 3 | 5 |
| Total | | | | 100 | 100 | 100 | 100 |
| Leveling agent | BYK377 | BYK | Polyether modified | 0.01 | 0.01 | 0.01 | 0.01 |
| | | | polydimethylsiloxane | | | | |

CN968: Hexafunctional aliphatic urethane acrylate having polyester backbone
SR610: Polyethylene glycol diacrylate and having average molecular weight of polyethylene glycol chain of 600
PGM-AC-4130Y: Silica sol surface-modified with methacryloyl group-containing silane compound, dispersion medium propylene glycol monomethyl ether
Ominirad184: 1-hydroxy-cyclohexyl-phenyl-ketone

### Example 1

A 50 μm thick PET film was used as the transparent base material, and after the composition 1 was applied to the PET film by a bar coater, the composition 1 was photopolymerized to form a 5 μm thick hard coat layer on the transparent base material.

Next, the surface of the hard coat layer was subjected to a surface treatment by glow discharge treatment at an electrode power density of 5,500 W/m². Next, an Si target and an Nb target were used as sputtering targets on the hard coat layer, and an adhesion layer and an optical function layer were formed continuously by a reactive sputtering method using a mixture gas of Ar gas and O₂ gas.

That is, a 3 nm adhesion layer composed of Si oxide (SiOx, 0<x<2) having a possible oxygen deficiency, a first high refractive index material layer composed of Nb₂O₅ having a thickness of 10 nm, a first low refractive index material layer composed of SiO₂ having a thickness of 26 nm, a second high refractive index material layer composed of Nb₂O₅ having a thickness of 110 nm, and a second low refractive index material layer composed of SiO₂ having a thickness of 85 nm were deposited on the hard coat layer in this order.

Next, an antifouling layer having a thickness of 3 nm composed of an alkoxysilane compound having a perfluoropolyether group (KY1903-1, made by Shin-Etsu Chemical Co., Ltd.) was formed by vapor deposition on the SiO₂ film of the top layer of the optical function layer at a pressure of 0.01 Pa in the vapor deposition chamber, a vapor deposition temperature of 230° C., and a holding time of 7.2 s, producing an optical laminate (antireflective film) of an example.

### Example 2

An optical laminate was obtained in the same manner as in Example 1, except that the electrode power density during glow discharge treatment was changed from 5,500 W/m² to 1,100 W/m².

### Example 3

An optical laminate was obtained in the same manner as in Example 1, except that the electrode power density of the glow discharge treatment was changed from 5,500 W/m² to 6,600 W/m².

### Example 4

An optical laminate was obtained in the same manner as in Example 1, except that the thickness of the hard coat layer formed on the transparent base material was set to 2 μm.

### Example 5

An optical laminate was obtained in the same manner as in Example 1, except that the composition for the hard coat layer was changed to composition 2.

### Example 6

An optical laminate was obtained in the same manner as in Example 1, except that the composition for the hard coat layer was changed to composition 3.

### Example 7

An optical laminate was obtained in the same manner as in Example 1, except that a 23 μm PET film was used instead of a 50 μm thick PET film as the transparent base material.

### Example 8

An optical laminate was obtained in the same manner as in Example 1, except that the thickness of the hard coat layer formed on the transparent base material was set to 10 μm.

### Example 9

An optical laminate was obtained in the same manner as in Example 8, except that the electrode power density during glow discharge treatment was changed from 5,500 W/m² to 3,300 W/m².

### Example 10

An optical laminate was obtained in the same manner as in Example 8, except that the electrode power density during glow discharge treatment was changed from 5,500 W/m² to 1,100 W/m².

### Example 11

An optical laminate was obtained in the same manner as in Example 8, except that the electrode power density during glow discharge treatment was changed from 5,500 W/m² to 550 W/m².

### Comparative Example 1

An optical laminate was obtained in the same manner as in Example 1, except that composition 1 for forming the hard coat layer was changed to composition 4 shown in Table 1, and the electrode power density during glow discharge treatment was set to 5,000 W/m².

### Comparative Example 2

An optical laminate was obtained in the same manner as in Comparative Example 1, except that the thickness of the hard coat layer formed on the transparent base material was set to 10 μm and the electrode power density during glow discharge treatment was changed from 5,000 W/m² to 1,100 W/m².

Next, the optical laminates obtained in Examples 1 to 11 and Comparative Examples 1 to 2 were measured and evaluated using the following method.

### <Bending Test>

An optical laminate cut into 1 cm×15 cm was prepared as a sample. It was confirmed that the optical laminate had no cracks on the cut surface.

A 5.0 mm mandrel was set in a bending tester in which the mandrel could be set. The optical laminate described above was set in this tester so that the surface on which the antifouling layer was formed could be bent to the outside. Thereafter, the optical laminate was bent 180° by bending the tester over 2 seconds and held for 10 seconds. Thereafter, the presence of cracks in the antifouling layer was confirmed by visual inspection and optical microscope.

The above procedure was repeated while replacing the mandrel diameter with a smaller one in 0.2 mm increments until an abnormality such as a crack was observed on the surface of the antifouling layer side of the optical laminate by visual inspection and optical microscope, and the diameter of the mandrel (φmm) that was 0.2 mm larger than the diameter of the mandrel where cracks were first found was set as the result of the bending test.

In the same manner, the same was also measured when the optical laminate was set in the above tester such that the surface on which the antifouling layer was formed was bent to the inside, and the diameter of the mandrel (φmm) that was 0.2 mm larger than the diameter of the mandrel where cracks were first found was set the result of the bending test.

Furthermore, a theoretical stretching rate S (%) of the optical function layer was calculated when a mandrel of the smallest diameter without cracks was used. The stretching rate S was calculated as follows.

$$S ( \% ) = \{ ( R 2 / R 1 ) - 1 \} \times 100$$

(Here, R2 is a distance from the axial center of the mandrel to the outside surface of the optical laminate, and R1 is a distance from the axial center of the mandrel to a virtual line indicating a position corresponding to ½ of the total thickness of the optical laminate)

Furthermore, when the surface on which the antifouling layer was formed was set so as to be bent to the inside, a theoretical compression rate C (%) of the optical function layer was calculated when a mandrel of the smallest diameter without cracks was used. The compression rate C was calculated as follows.

$$C ( \% ) = \{ 1 - ( R 3 / R 1 ) \} \times 100$$

(Here, R3 is a distance from the axial center of the mandrel to the surface of the antifouling layer side of the optical laminate, and R1 is a distance from the axial center of the mandrel to a virtual line indicating a position corresponding to ½ of the total thickness of the optical laminate)

Note that three measurements were prepared for each sample, and each value was determined from the average value of the three measurements. Furthermore, the smallest mandrel diameter was 1.0 φmm, and 1.0 φmm was used for the measurement of stretching rate, but as there were no cracks, the result of the bending test was set to be less than 1.0 φmm.

### <Martens Hardness>

A laminate (sample) in which only the hard coat layer was formed on the transparent base material was respectively prepared using compositions 1 to 4.

For the optical laminates obtained in Examples 1 to 11 and Comparative Examples 1 to 2, the Martens hardness on the antifouling layer side of the optical laminate was measured, respectively. For a laminate in which only the hard coat layer was formed, the Martens hardness on the hard coat side of the laminate was measured. For the measurement, a microcompression tester (Elionix, ENT-NEXUS, measuring indenter: Berkovich indenter) was used in accordance with ISO 14577-1. For the optical laminate, the hardness at a pushing depth of 50 nm was determined, and for the laminate in which only the hard coat layer was formed, the hardness when pushed to a depth of 1/10 of the thickness of the hard coat layer was determined.

Furthermore, the Martens hardness of the optical laminate measured above was set to (A), and the Martens hardness of the laminate in which only the hard coat layer was formed on the transparent base material was set to (B), and the ratio (A)/(B) of these was calculated. The results are shown in Table 2.

Furthermore, the optical laminates obtained in Examples 1 to 11 and Comparative Examples 1 to 2 were measured and evaluated using the following method.

### <Contact Angle Measurement Test for Pure Water>

A fully automatic contact angle meter DM-700 (manufactured by Kyowa Interface Chemical Co., Ltd.) was used, and measurement was performed by an elliptic fitting method under the following conditions. Pure water was placed in a glass syringe, and a stainless steel needle was attached to the tip thereof, and the pure water was dripped onto an optical laminate (test specimen).
Dropwise amount of pure water: 2.0 μL
Measurement temperature: 25° C.

The contact angle after 4 seconds of pure water being dripped onto the laminate (sample) was measured at any six locations on the surface of the test specimen, and the average value thereof was set as the pure water contact angle.

### <Steel Wool Sliding Test>

Using a friction tester I form conforming to JISL 0849, a friction body was horizontally reciprocated along the surface of the optical laminate (test specimen) to obtain a test specimen.

Steel wool (#0000 manufactured by Bonstar Corporation) was used as the friction body. The test settings were as follows: a load of 1,000 g/cm², a sliding distance of 50 mm, a sliding speed of 60 rpm (1 reciprocation/second), and 200 slides (100 reciprocations).

The same test as the contact angle measurement test for the above pure was performed on the sample after sliding to obtain the difference in the contact angle before and after the test.

The results are shown in Table 3.

TABLE 2

| | | | | | | | | | Example 7 | |
|---|---|---|---|---|---|---|---|---|---|---|
| | | | | | | | | | (base | |
| | | | | | | | | | material: | |
| | | | | | | | | | 23 μm PET | Comparative |
| | | | Example 1 | Example 2 | Example 3 | Example 4 | Example 5 | Example 6 | film) | Example 1 |
| Composition for hard coat layer | | | Composi- | Composi- | Composi- | Composi- | Composi- | Composi- | Composi- | Composi- |
| | | | tion 1 | tion 1 | tion 1 | tion 1 | tion 2 | tion 3 | tion 1 | tion 4 |
| Electrode power density during | | | 5,500 | 1,100 | 6,600 | 5,500 | 5,500 | 5,500 | 5,500 | 5,000 |
| glow discharge treatment (W/m²) | | | | | | | | | | |
| Thickness of hard coat layer (μm) | | | 5 | 5 | 5 | 2 | 5 | 5 | 5 | 5 |
| Martens | Hardness of | (N/ | 1,465 | 1,370 | 1,433 | 1,458 | 1,468 | 1,470 | 1,458 | 1,465 |
| hardness | optical | mm²) | | | | | | | | |
| | laminate (A) | | | | | | | | | |
| | Hardness of | (N/ | 432 | | | 430 | 413 | 462 | 425 | 395 |
| | laminate (B) | mm²) | | | | | | | | |
| | (A)/(B) | (—) | 3.39 | 3.17 | 3.32 | 3.39 | 3.55 | 3.18 | 3.43 | 3.71 |
| Bending | Compression | (%) | 5.23< | 5.23< | 5.23< | 4.96< | 5.23< | 5.23< | 2.74< | 4.4 |
| test | rate C (inside | | | | | | | | | |
| | bending) | | | | | | | | | |
| | Mandril | (φmm) | <1.0 | <1.0 | <1.0 | <1.0 | <1.0 | <1.0 | <1.0 | 1.2 |
| | diameter | | | | | | | | | |
| | (inside | | | | | | | | | |
| | bending) | | | | | | | | | |
| | Stretching rate | (%) | 2 | 1.6 | 1.18 | 1.97 | 1.87 | 1.81 | 2.12 | 1.24 |
| | S (outside | | | | | | | | | |
| | bending) | | | | | | | | | |
| | Mandril | (φmm) | 2.7 | 3.4 | 3 | 2.6 | 2.9 | 3.0 | 1.3 | 4.4 |
| | diameter | | | | | | | | | |
| | (outside | | | | | | | | | |
| | bending) | | | | | | | | | |
| Steel wool | Contact angle | (°) | 121.3 | 120.7 | 121.2 | 119.8 | 120.8 | 119.5 | 119.6 | 119.1 |
| sliding | with pure | | | | | | | | | |
| test | water before | | | | | | | | | |
| | testing | | | | | | | | | |
| | Contact angle | (°) | 112 | 108.3 | 111.2 | 109.8 | 112 | 106.5 | 109.8 | 97.35 |
| | with pure | | | | | | | | | |
| | water after | | | | | | | | | |
| | testing | | | | | | | | | |

| | | | | | | | | |
|---|---|---|---|---|---|---|---|---|
| Difference in contact | 9.3 | 12.4 | 10 | 10 | 8.8 | 12.9 | 9.8 | 21.75 |
| angle before and after | | | | | | | | |
| testing | | | | | | | | |

TABLE 3

| | | | | | | | Comparative |
|---|---|---|---|---|---|---|---|
| | | | Example 8 | Example 9 | Example 10 | Example 11 | Example 2 |
| Composition for hard coat layer | | | Composition | Composition | Composition | Composition | Composition |
| | | | 1 | 1 | 1 | 1 | 2 |
| Electrode power density during | | | 5,500 | 3,300 | 1,100 | 550 | 1,100 |
| glow discharge treatment (W/m²) | | | | | | | |
| Thickness of hard coat layer (μm) | | | 10 | 10 | 10 | 10 | 10 |
| Martens Hardness of optical | | | 1,126 | 1,201 | 1,054 | 1,116 | 1,083 |
| laminate (A) (N/mm²) | | | | | | | |
| Martens Hardness of laminate (B) | | | 493 | 493 | 493 | 493 | 398 |
| (N/mm²) | | | | | | | |
| (A)/(B) | | | 2.29 | 2.43 | 2.13 | 2.27 | 2.72 |
| Bending | Compression | (%) | 5.68< | 5.68< | 4.78 | 4.78 | 3.63 |
| test | rate C (inside | | | | | | |
| | bending) | | | | | | |
| | Mandril | (φmm) | <1 mm | <1 mm | 1.2 mm | 1.2 mm | 1.6 mm |
| | diameter | | | | | | |
| | (inside | | | | | | |
| | bending) | | | | | | |
| | Stretching rate | (%) | 1.97 | 1.97 | 2.03 | 1.74 | 1.29 |
| | S (outside | | | | | | |
| | bending) | | | | | | |
| | Mandril | (φmm) | 3.0 mm | 3.0 mm | 2.9 mm | 3.4 mm | 4.6 mm |
| | diameter | | | | | | |
| | (outside | | | | | | |
| | bending) | | | | | | |

| | | | | | | |
|---|---|---|---|---|---|---|
| Steel | Contact angle with | 119.7 | 119.7 | 117.4 | 117.3 | 119.5 |
| wool | pure water before | | | | | |
| sliding | testing (°) | | | | | |
| test | Contact angle with | 108.5 | 108.1 | 107.7 | 106.8 | 95.9 |
| | pure water after | | | | | |
| | testing (°) | | | | | |
| | Difference in contact | 11.2 | 11.6 | 9.7 | 10.5 | 23.6 |
| | angle before and after | | | | | |
| | testing | | | | | |

From the results of Table 2, it was found that in each of the Examples 1 to 7, the ratio (A)/(B) between the Martens hardness (A) on the antifouling layer side of the optical laminate and the Martens hardness (B) on the hard coat layer side of the laminate having only the transparent base material and the hard coat layer is 3.6 or less, and thus the bending resistance may be further improved while achieving excellent hardness. In particular, it was thought that the surface modification of the silica particles contained in the hard coat layer by a methacryloyl group derived from a methacryloyl group-containing silane compound led to a stronger bonding of the methacryloyl group to an acrylate (binder resin), which was found to result in an improved hardness of the optical laminate. Moreover, it was found that the adhesion between the hard coat layer, the adhesion layer, and the optical function layer via the adhesion layer was further improved by the methacryloyl group on the surface of the silica particles, and the bending resistance was further improved.

Furthermore, in each of the Examples 1 to 7, the difference in contact angle with respect to water between before and after friction is 20° or less in a case where steel wool is horizontally reciprocated 200 times, and it was thought that the surface modification of the silica particles contained in the hard coat layer by a methacryloyl group derived from a methacryloyl group-containing silane compound led to a stronger bonding of the methacryloyl group to an acrylate (binder resin), which was found to result in an improved hardness of the optical laminate and achieving excellent scratch resistance.

Furthermore, from the results of Table 3, it was found that in each of the Examples 8 to 11, as in the Examples 1 to 7, the difference in contact angle with respect to water between before and after friction is 20° or less in a case where steel wool is horizontally reciprocated 200 times, hardness of the optical laminate is improved, and excellent scratch resistance is achieved. Furthermore, the ratio (A)/(B) between the Martens hardness (A) on the antifouling layer side of the optical laminate and the Martens hardness (B) on the hard coat layer side of the laminate having only the transparent base material and the hard coat layer is 3.6 or less, and thus the bending resistance may be further improved while achieving excellent hardness.

On the other hand, in Comparative Example 1, when the hard coat layer was formed using the composition 4 containing surface-unmodified silica particles, the above ratio ((A)/(B)) was 3.71, and the hardness of the laminate became low. Furthermore, the stretching rate S (outside bending) was 1.22, the compression rate C (inside bending) was 4.4, and the bending resistance was inferior.

Furthermore, in Comparative Example 2, when the hard coat layer was formed using the composition 2 containing surface-unmodified silica particles, the difference in contact angle was 23.6° and a decrease in scratch resistance was seen. Furthermore, the stretching rate S (outside bending) was 1.29, the compression rate C (inside bending) was 3.63, and the bending resistance was inferior.

### DESCRIPTION OF REFERENCE NUMERALS

10, 102 . . . Optical laminate
11 . . . Transparent base material
12 . . . Hard coat layer
13 . . . Adhesion layer
14 . . . Optical function layer
14a . . . High refractive index layer
14b . . . Low refractive index layer
15 . . . Antifouling layer
20 . . . Manufacturing device
1 . . . Sputtering device
2A, 2B . . . Preprocessing device
3 . . . Vapor deposition device
4 . . . Roll unwinding device
5 . . . Roll winding device
20 . . . Manufacturing device
21 . . . Vacuum pump
22 . . . Guide roll
23 . . . Unwinding roll
24 . . . Winding roll
25 . . . Deposition roll
26 . . . Can roll
31, 32, 33, 34, 35 . . . Chamber
41 . . . Deposition unit
42 . . . Plasma discharge device
43 . . . Deposition source
53 . . . Heating device

1. An optical laminate comprising in the following order: a transparent base material; a hard coat layer; an adhesion layer comprising a sputtered film; an optical function layer in which high refractive index layers each comprising a sputtered film and low refractive index layers each having a refractive index lower than a refractive index of the high refractive index layer are alternately laminated; and an antifouling layer, wherein
the hard coat layer comprises a silica filler, and
the optical laminate satisfies condition 1 and condition 2,
Condition 1: A ratio ((A)/(B)) of the Martens hardness (A) measured from the antifouling layer side of the optical laminate to the Martens hardness (B) measured from the hard coat layer side of a laminate having only the transparent base material and the hard coat layer is 3.6 or less, Condition 2: A difference in contact angle with respect to water between before and after friction is 20° or less, the friction being performed, using a friction tester with steel wool conforming to JIS L0849, by horizontally reciprocating the steel wool 200 times.

2. The optical laminate according to claim 1, wherein the silica filler is surface modified by a functional group derived from a silane compound.

3. The optical laminate according to claim 2, wherein the silane compound is at least one compound selected from a vinyl group-containing silane compound, a (meth)acryloyl group-containing silane compound, an amino group-containing silane compound, an isocyanate group-containing silane compound, an isocyanurate group-containing silane compound, an epoxy group-containing silane compound, and a mercapto group-containing silane compound.

4. The optical laminate according to claim 2, wherein the silane compound is a (meth)acryloyl group-containing silane compound.

5. The optical laminate according to claim 2, wherein the hard coat layer comprises a binder resin having a functional group and the silica filler, and
the functional group derived from the silane compound has the same functional group as the binder resin.

6. The optical laminate according to claim 5, wherein the binder resin comprises a (meth)acrylate compound, and
the functional group derived from the silane compound is a (meth)acryloyl group.

7. The optical laminate according to claim 1, wherein an average particle size of the silica filler is 800 nm or less.

8. The optical laminate according to claim 1, wherein a thickness of the hard coat layer is 0.5 μm or more and 100 μm or less.

9. The optical laminate according to claim 1, wherein, when the optical laminate is bent 180° around a mandrel so that a surface on which the antifouling layer is formed is on an outside, a stretching rate S (%) of the optical function layer calculated by formula (1) satisfies 1.3≤S when the mandrel has the smallest diameter in which the optical laminate does not crack,
$$S ( \% ) = \{ ( R 2 / R 1 ) - 1 \} \times 100 \qquad ( 1 )$$
wherein R2 is a distance from an axial center of the mandrel to an outer surface of the optical laminate, and R1 is a distance from the axial center of the mandrel to a virtual line indicating a position corresponding to ½ of a total thickness of the optical laminate.

10. The optical laminate according to claim 9, wherein, when the optical laminate is bent 180° around a mandrel so that the surface on which the antifouling layer is formed is on an inside, a compression rate C (%) of the optical function layer calculated by formula (2) satisfies 4.5≤C when the mandrel has the smallest diameter in which the optical laminate does not crack,
$$C ( \% ) = \{ 1 - ( R 3 / R 1 ) \} \times 100 \qquad ( 2 )$$
wherein R3 is a distance from the axial center of the mandrel to a surface of the antifouling layer side of the optical laminate, and R1 is a distance from the axial center of the mandrel to a virtual line indicating a position corresponding to ½ of the total thickness of the optical laminate.

11. An article comprising the optical laminate according to claim 1.
